(19) United States
(12) Patent Application Publication
(10) Pub. No.: US 2023/0044767 A1
(43) Pub. Date: Feb. 9, 2023

(54) STRUCTURE FOR PREVENTING VIBRATIONS OF EQUIPMENT

(71) Applicant: GNI. Co.,Ltd., Hwaseong-si (KR)

(72) Inventor: Chang Su LIM, Hwaseong-si (KR)

(21) Appl. No.: 17/581,852

(22) Filed: Jan. 21, 2022

(30) Foreign Application Priority Data
Jul. 21, 2021 (KR) 10-2021-0095309

(51) Int. Cl. F16F 1/40; F16F 15/08; F16F 1/373

(52) U.S. Cl. CPC F16F 1/40; F16F 15/08; F16F 1/373

(57) ABSTRACT

Disclosed is a structure for preventing vibrations of equipment, which is capable of preventing vibrations generated by equipment disposed in an industrial facility, a bogie, a facility disposed in a clean room, or the like from being transmitted to the outside of the equipment. The vibrations generated by the equipment may be blocked from being transmitted to a steel grating, which is a lower structure, through a wheel by mounting an anti-vibration unit for blocking the vibrations generated by the equipment on the wheel mounted on a lower end of the equipment. In addition, vibrations, which are transmitted through a fixing bolt, of the equipment may be blocked by forming the anti-vibration unit to surround the fixing bolt for fixing the wheel to the equipment.

### CLAIM FOR PRIORITY

This application claims priority to Korean Patent Application No. 2021-0095309 filed on Jul. 21, 2021 in the Korean Intellectual Property Office (KIPO), the entire contents of which are hereby incorporated by reference.

### BACKGROUND

### 1. Technical Field

Example embodiments of the present disclosure relate to a structure for preventing vibrations of equipment, and more specifically, to a structure for preventing vibrations of equipment, which is simply mounted and is capable of preventing vibrations generated by the equipment from being transmitted to the outside of the equipment.

### 2. Related Art

Recently, a structure for preventing vibrations, which blocks vibrations, is mounted under equipment in order to control minute vibrations and shaking applied in an industrial facility. The mounted structure for preventing vibrations is generally disposed under each of four corners of the equipment to support the equipment and block the vibrations.

However, the conventional method of preventing vibrations uses a method of simply mounting an anti-vibration block formed of a rubber material under equipment and fixing the mounted anti-vibration block to a steel grating, which is a lower structure, in order to block vibrations generated by the equipment. Through such a method, the vibrations generated by the equipment may be blocked to some extent, but the effect is insignificant, and when the anti-vibration block is mounted or removed, an accident may occur in which an operator's hand is caught by the heavy equipment. In addition, even when the anti-vibration block is mounted on a lower end of the equipment, since the vibrations generated by the equipment are transmitted to the steel grating, which is the lower structure, through a bolt for fixing the anti-vibration block, there is a limitation in blocking the vibrations generated by the equipment.

### SUMMARY

Accordingly, example embodiments of the present inventive concept are provided to substantially obviate one or more problems due to limitations and disadvantages of the related art. That is, example embodiments of the present inventive concept provide a structure for preventing vibrations of equipment, which is easily mounted and is capable of blocking vibrations generated by the equipment from being transmitted through a bolt or a wheel of the equipment.

In some example embodiments, an structure for preventing vibrations of equipment includes a plate on which a wheel is mounted and which has fastening holes to be fixed to equipment, a plurality of fixing bolts which are inserted into the fastening holes to fix the plate to the equipment, a first anti-vibration unit disposed between a head portion of the fixing bolt and the plate, and a second anti-vibration unit disposed between the plate and the equipment.

The first anti-vibration unit may include a first anti-vibration block which allows the fixing bolt to press the plate and a first anti-vibration member disposed between the first anti-vibration block and the plate.

The first anti-vibration block may include a first seating portion into which the first anti-vibration member is fixedly inserted.

The first anti-vibration member inserted into the first seating portion may be disposed to protrude from the first anti-vibration block.

The first anti-vibration unit may have a bar shape, and each of one end and the other end of the first anti-vibration unit may be formed in a circular shape.

The fixing bolt may be mounted in each of the one end and the other end of the first anti-vibration unit.

The first anti-vibration unit may have a circular or quadrangular ring shape in which a hollow portion is formed in a central portion and all of the plurality of fixing bolts are fastened to a periphery portion.

The first anti-vibration unit may have a size greater than or equal to a size of the plate.

The first anti-vibration unit may have a circular shape.

The first anti-vibration unit may be mounted on each of the fixing bolts fastened to the plate.

The second anti-vibration unit may include a second anti-vibration block in contact with the equipment and a second anti-vibration member disposed between the second anti-vibration block and the plate.

The second anti-vibration block may include a second seating portion into which the second anti-vibration member is fixedly inserted.

The second anti-vibration member inserted into the second seating portion may be disposed to protrude from the second anti-vibration block.

The second anti-vibration member may have an area greater than or equal to an area of the plate.

The structure for preventing vibrations may further include a packing disposed in the fastening hole of the plate.

### BRIEF DESCRIPTION OF DRAWINGS

Example embodiments of the present inventive concept will become more apparent by describing example embodiments of the present inventive concept in detail with reference to the accompanying drawings, in which:

FIG. 1 is a perspective view illustrating a structure for preventing vibrations according to a first embodiment of the present inventive concept;

FIG. 2 is an exploded view illustrating the structure for preventing vibrations illustrated in FIG. 1;

FIG. 3 is a view illustrating a first anti-vibration unit of the structure for preventing vibrations illustrated in FIG. 1;

FIG. 4 is a view illustrating an aspect in which the structure for preventing vibrations illustrated in FIG. 1 is mounted on equipment;

FIG. 5 is a perspective view illustrating a structure for preventing vibrations according to a second embodiment of the present inventive concept;

FIG. 6 is a view illustrating a first anti-vibration unit of the structure for preventing vibrations illustrated in FIG. 5;

FIG. 7 is a perspective view illustrating a structure for preventing vibrations according to a third embodiment of the present inventive concept;

FIG. 8 is an exploded view illustrating the structure for preventing vibrations illustrated in FIG. 7; and

FIG. 9 is a view illustrating a first anti-vibration unit of the structure for preventing vibrations illustrated in FIG. 7.

### DESCRIPTION OF EXAMPLE EMBODIMENTS

Since the present inventive concept allows for various changes and numerous embodiments, specific embodiments will be illustrated in the accompanying drawings and described in the detailed description. However, this is not intended to limit the present inventive concept to the specific embodiments, and it is to be appreciated that all changes, equivalents, and substitutes that do not depart from the spirit and technical scope of the present inventive concept are encompassed in the present inventive concept. In the description of the embodiments, certain detailed descriptions of the related art are omitted when it is deemed that they may unnecessarily obscure the gist of the inventive concept.

Hereinafter, embodiments of the present inventive concept will be described in detail with reference to the accompanying drawings, and in the description with reference to the accompanying drawings, the components that are the same or correspond to each other will be denoted by the same reference numerals, and redundant descriptions will be omitted.

Generally, a structure for preventing vibrations is mounted under equipment (a pump, a chiller, an air conditioner, a blower, and the like) of an industrial facility, a bogie which carries goods, or a facility disposed in a clean room and is used to block vibrations generated by the equipment or facility from being transmitted to the outside or to block vibrations being transmitted to the equipment or facility from the outside. Generally, since the equipment disposed in the industrial facility, the facility, and the like are heavy, and the bogie carries heavy goods, wheels are mounted on a lower portion thereof. That is, even when an anti-vibration device including a rubber material is disposed between the equipment, the bogie, or the facility of the clean room and a lower structure G, vibrations generated by the equipment or the facility may be transmitted to the lower structure G through the wheels. Accordingly, in the equipment, the bogie, the facility of the clean room, and the like in which the vibrations are generated, a structure for preventing vibrations capable of blocking the vibrations may be mounted in order to block the vibrations generated thereby from the outside.

Accordingly, the present inventive concept provides a structure for preventing vibrations which allows an anti-vibration unit to be mounted on a wheel in order to block vibrations transmitted through the wheel in contact with a lower structure G without mounting a separate anti-vibration device on, for example, equipment used in an industrial facility, a bogie, or a facility of a clean room, in which vibrations are generated.

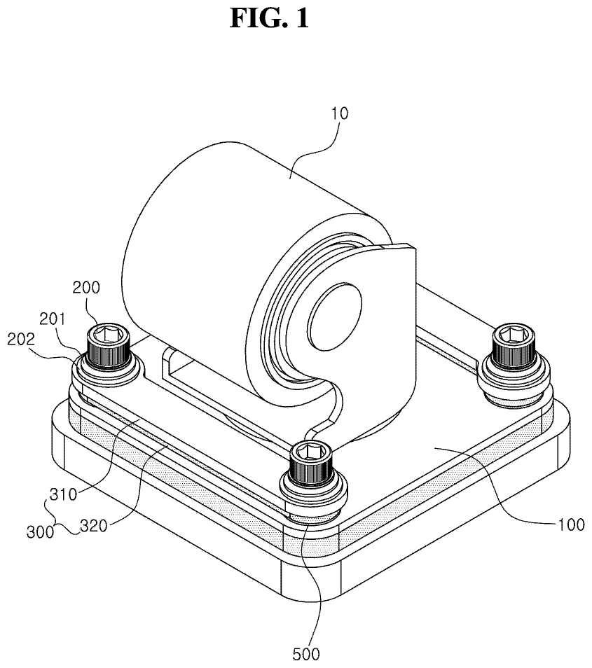

FIG. 1 is a perspective view illustrating a structure for preventing vibrations according to a first embodiment of the present inventive concept.

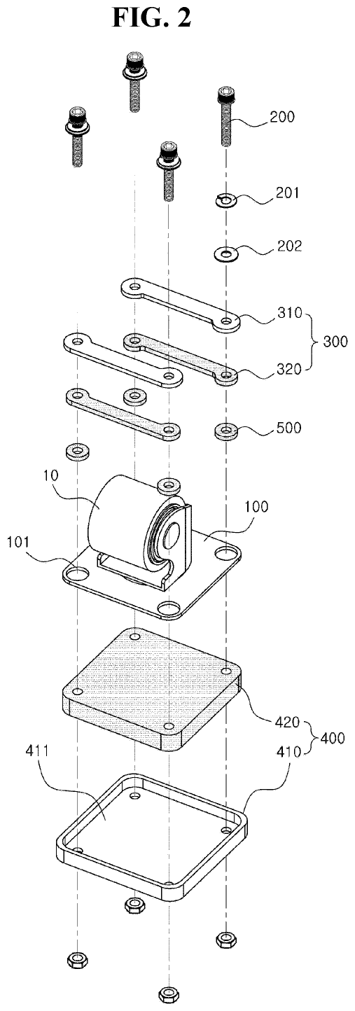

FIG. 2 is an exploded view illustrating the structure for preventing vibrations illustrated in FIG. 1.

Referring to FIGS. 1 and 2, the structure for preventing vibrations according to the first embodiment of the present inventive concept includes a plate 100 on which a wheel 10 is mounted and which includes fastening holes 101 for fixing equipment, a plurality of fixing bolts 200 inserted into the fastening holes 101 of the plate 100 to fix the plate 100 to the equipment, first anti-vibration units 300 disposed between heads of the fixing bolts 200 and the plate 100, and a second anti-vibration unit 400 disposed between the plate 100 and the equipment. In this case, the equipment, on which the structure for preventing vibrations is mounted, may include any equipment, such as a bogie or facility disposed in a clean room, on which a wheel is mounted in an industrial facility.

The plate 100 is disposed between the wheel 10 and the equipment in order to mount the wheel 10 on the equipment. More specifically, the wheel 10 may be attached to one surface of the plate 100, and the other surface thereof may be disposed on a lower surface of the equipment. The fixing bolt 200 is generally used to mount the wheel 10 attached to the plate 100 to a lower portion of the equipment. Accordingly, the plate 100 includes the fastening holes 101, into which the fixing bolts 200 are mounted, at edge portions (generally, corners) of the plate 100 so that the fixing bolts 200 may be mounted in the equipment through the plate 100. As an example, when the plate 100 has a quadrangular shape, and the wheel 10 is mounted on a central portion of one surface of the plate 100, the fastening hole 101 may be formed in each of the corners of the plate 100. In addition, the plate 100 may be formed in a polygonal or circular shape instead of the quadrangular shape, and positions and the number of fastening holes 101 may be determined according to the shape of the plate 100.

Packings 500 may be disposed in the fastening holes 101. As an example, the packing 500 may be formed of an elastic rubber material to absorb vibrations, which are transmitted through the fixing bolt 200, of the equipment. That is, the vibrations generated by the equipment may be transmitted to the plate 100 through the fixing bolt 200 due to a metal of the fixing bolt 200 formed of a metal material and a metal of the plate 100 which are in contact with each other. Accordingly, the vibrations transmitted through the fixing bolt 200 may be blocked by the packing 500 which is formed of the elastic rubber material and inserted into a portion in which the fixing bolt 200 and the plate 100 are in contact with each other.

The fixing bolt 200 may be a general fixing bolt which has a male thread formed on an outer circumference of the bolt in a longitudinal direction. The fixing bolt 200 may be inserted into the fastening hole 101 formed in the plate 100 to fix the plate 100 to the equipment. In this case, the fixing bolt 200 may be fixed by a tap formed in a lower bottom surface of the equipment or by a nut structure press-fitted to an inner surface of a lower bottom of the equipment.

In addition, when the plate 100 is fixed to the equipment using the fixing bolt 200, as an example, the fixing bolt 200 may be fastened to the equipment using a spring washer 201 and a flat washer 202. The spring washer 201 may be used to prevent the fixing bolt 200 from being loosened due to minute vibrations after the fixing bolt 200 is mounted, and the flat washer 202 may be used to prevent a scratch and the like from being generated on a surface of the plate 100 by the spring washer 201 or the fixing bolt 200. Accordingly, the fixing bolt 200 may be inserted into the fastening hole 101 of the plate 100 to be fixed to the equipment after the spring washer 201 and the flat washer 202 are sequentially mounted.

In this case, the present inventive concept may include the first anti-vibration unit 300 disposed between the flat washer 202 and the plate 100.

As an example, when the spring washer 201 and the flat washer 202 are used between the head portion of the fixing bolt 200 and the plate 100, the first anti-vibration unit 300 may be disposed between the flat washer 202 and the plate 100. Accordingly, vibrations generated by the equipment may be suppressed from being transmitted to the outside through the fixing bolt 200.

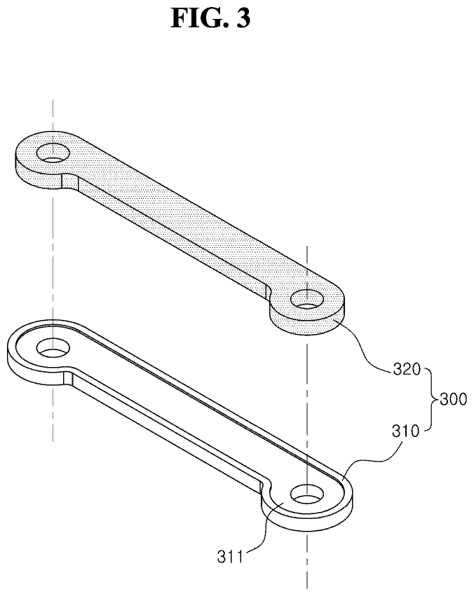

FIG. 3 is a view illustrating the first anti-vibration unit of the structure for preventing vibrations illustrated in FIG. 1.

Referring to FIGS. 1 to 3, the first anti-vibration units 300 of the structure for preventing vibrations according to the first embodiment may include first anti-vibration blocks 310 and first anti-vibration members 320.

The first anti-vibration block 310 may be mounted so that one surface thereof is in contact with the head portion of the fixing bolt 200 or the flat washer 202 and presses the first anti-vibration member 320, which will be described below, to fix the first anti-vibration member 320 to the plate 100. That is, when the first anti-vibration member 320 is mounted, as the fixing bolt 200 presses the first anti-vibration block 310 disposed on the first anti-vibration member 320 instead of pressing the first anti-vibration member 320, and the first anti-vibration block 310, of which an area is greater than an area of the head portion of the fixing bolt 200, presses the first anti-vibration member 320, damage to the first anti-vibration member 320 by the fixing bolt 200 may be prevented.

The first anti-vibration block 310 may have a size which does not interfere with the wheel 10 when the first anti-vibration block 310 is mounted on the plate 100 using the fixing bolt 200. As an example, the first anti-vibration block 310 may have a bar shape, and each of one end and the other end may have a circular shape. In this case, the circular one end and the circular other end may be portions formed with fastening holes into which the fixing bolts 200 are inserted. That is, one end and the other end of the first anti-vibration unit 300 formed in the bar shape may be portions into which the fixing bolts 200 coupled to the spring washers 201 and the flat washers 202 are inserted and press the first anti-vibration unit 300.

In addition, the other surface of the first anti-vibration block 310 may include a first seating portion 311 into which the first anti-vibration member 320 is inserted and seated thereon. The first seating portion 311 may be formed in the same shape as a shape of the first anti-vibration member 320 and may have the same size as a size of first anti-vibration member 320 so that the first anti-vibration member 320 is fixedly inserted into the first seating portion 311.

However, when the first anti-vibration member 320 is inserted into and seated on the first seating portion 311, the first anti-vibration member 320 may be disposed to protrude from the first anti-vibration block 310. This is for preventing the first anti-vibration block 310 formed of the metal material and the plate 100 from being in contact with each other.

The first anti-vibration member 320 may be disposed between the first anti-vibration block 310 and the plate 100. As an example, the first anti-vibration member 320 may be formed of an elastic rubber material to absorb vibrations, which are transmitted through the fixing bolt 200, of the equipment.

As described above, the first anti-vibration member 320 may be inserted into the first seating portion 311 of the first anti-vibration block 310 and fixedly compressed to the plate 100 by a pressing force of the first anti-vibration block 310 when the fixing bolt 200 is coupled thereto. That is, the first anti-vibration member 320 may block the fixing bolt 200 from being in direct contact with the plate 100.

In addition, in the first anti-vibration unit 300 having the bar shape, a plurality of fixing bolts 200 may be coupled to one first anti-vibration unit 300. As an example, as illustrated in FIGS. 1 and 2, four fixing bolts 200 are fastened to the corners of the plate 100 having the quadrangular shape, two adjacent fixing bolts 200 may be coupled to one end and the other end of the first anti-vibration unit 300 having the bar shape and coupled to one side of the plate 100. In addition, the two remaining fixing bolts 200 may be coupled to the other side, which is opposite to the first anti-vibration unit 300 coupled to one side of the plate 100, of the plate 100 using the first anti-vibration unit 300.

That is, since the plurality of fixing bolts 200 are fastened to one first anti-vibration unit 300, the plurality of fixing bolts 200 are bound at the same time, and thus the fixing bolts 200 may be constrained to each other by the first anti-vibration unit 300. Accordingly, since vibrations transmitted through the fixing bolts 200 may be suppressed due to a structure of the first anti-vibration unit 300 by which the plurality of fixing bolts 200 are constrained to each other, vibrations generated by an equipment 20 may be maximally blocked from being transmitted to the wheel 10 through the fixing bolts 200.

Then, referring to FIGS. 1 and 2, the second anti-vibration unit 400 may be disposed between the plate 100 and the lower surface of the equipment. Accordingly, the second anti-vibration unit 400 may block vibrations generated by the equipment from being transmitted to the plate 100.

In addition, the second anti-vibration unit 400 may include a second anti-vibration block 410 and a second anti-vibration member 420.

The second anti-vibration block 410 may be mounted so that one surface thereof is in contact with the lower surface of the equipment and may fixedly press the second anti-vibration member 420 which will be described below. The second anti-vibration block 410 may be formed in the same shape as the shape of the plate 100 and may have a size which is greater than or equal to a size of the plate 100.

The other surface, which is opposite to the one surface, of the second anti-vibration block 410 may include a second seating portion 411 into which the second anti-vibration member 420 is fixedly inserted. The second seating portion 411 may have the same shape as a shape of the second anti-vibration member 420 and may be formed to have the same size as a size of the second anti-vibration member 420 so that the second anti-vibration member 420 is fixedly inserted into the second seating portion 411.

However, when the second anti-vibration member 420 is inserted into and seated on the second seating portion 411, the second anti-vibration member 420 may be disposed to protrude from the second anti-vibration block 410. This is for preventing the second anti-vibration block 410 formed of a metal material and the plate 100 from being in contact with each other.

The second anti-vibration member 420 may be disposed between the second anti-vibration block 410 and the plate 100. As an example, the second anti-vibration member 420 may be formed of an elastic rubber material which is the same as that of the first anti-vibration member 320 to absorb vibrations of the equipment.

The second anti-vibration member 420 may have a size greater than or equal to a size of the plate 100 in order to block the vibrations generated by the equipment from being transmitted to the plate 100. That is, the second anti-vibration member 420 may block the plate 100, on which the wheel 10 is mounted, from being in direct contact with the equipment. Accordingly, the vibrations generated by the equipment may be blocked from being transmitted to the wheel 10 through the plate 100 by the second anti-vibration member 420. In addition, since the fixing bolt 200 is mounted in the equipment through a fastening hole formed in the second anti-vibration member 420, the vibrations transmitted through the fixing bolt 200 may also be blocked.

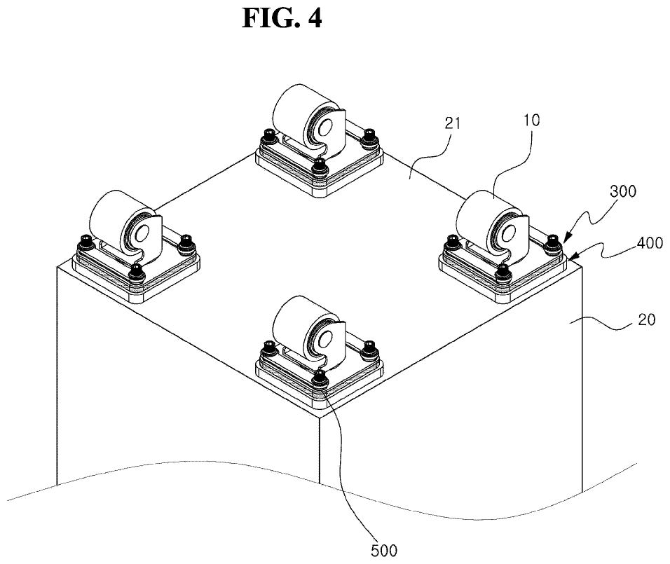

FIG. 4 is a view illustrating an aspect in which the structure for preventing vibrations illustrated in FIG. 1 is mounted on the equipment.

Referring to FIG. 4, the wheel 10 on which the anti-vibration units 300 and 400 of the present inventive concept are mounted may be mounted on a lower surface 21 of the equipment 20. In this case, the equipment 20 may include any equipment, such as a bogie or a facility disposed in a clean room, on which the wheel is mounted in an industrial facility.

As an example, the anti-vibration units 300 and 400 may be mounted on the wheel 10 mounted on the lower surface 21 of the equipment 20. That is, since the structure for preventing vibrations of the present inventive concept may be simply mounted when the wheel 10 is mounted in a manufacturing process of the equipment 20, there is no need to mount a separate device for preventing vibrations after the equipment 20 is brought into the industrial facility, as in the related art.

In addition, since the anti-vibration units 300 and 400 according to the present inventive concept are disposed to surround the fixing bolt 200, which fixes the plate 100, and between the lower surface 21 of the equipment 20 and the plate 100 which are connected through a metal material, vibrations generated by the equipment 20 may be blocked from being transmitted to the lower structure G through the wheel 10.

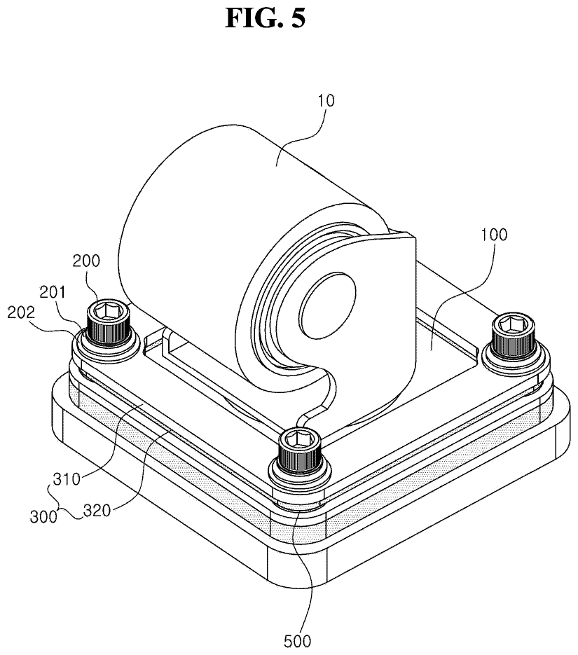

FIG. 5 is a perspective view illustrating a structure for preventing vibrations according to a second embodiment of the present inventive concept.

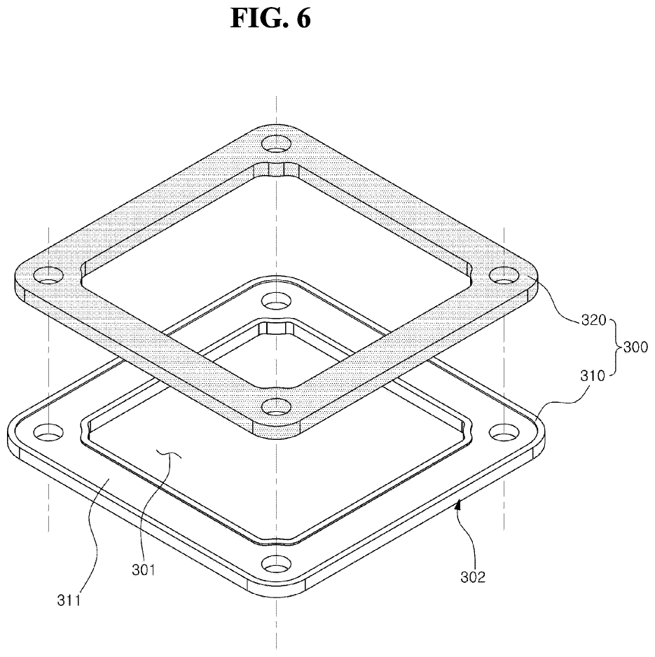

FIG. 6 is a view illustrating a first anti-vibration unit of the structure for preventing vibrations illustrated in FIG. 5.

Referring to FIGS. 5 and 6, in the structure for preventing vibrations according to the second embodiment of the present inventive concept, a fastening method of a plate 100 to which a wheel 10 is fixed, fixing bolts 200, a first anti-vibration unit 300, and a second anti-vibration unit 400 is the same as the fastening method thereof according to the first embodiment.

That is, the fixing bolt 200, to which a spring washer 201 and a flat washer 202 are coupled, is inserted into a fastening hole 101, in which a packing 500 is mounted, of the plate 100 using the first anti-vibration unit 300 and is mounted on a lower surface of an equipment 20 using the second anti-vibration unit 400.

However, in the first anti-vibration unit 300 of the structure for preventing vibrations according to the second embodiment, the plurality of fixing bolts 200 may be simultaneously fastened to the plate 100 through one first anti-vibration unit 300. That is, the first anti-vibration unit 300 according to the second embodiment may have a circular or quadrangular ring shape in which a hollow portion 301 is formed in a central portion thereof and all of the plurality of fixing bolts 200 are fastened to a periphery portion 302.

As an example, as shown in FIG. 5, when four fixing bolts 200 are fastened to corners of the plate 100 having a quadrangular shape, all four fixing bolts 200 may be fastened to the periphery portion 302, that is, the corners, of the first anti-vibration unit 300 having the quadrangular ring shape. In this case, corner portions of the first anti-vibration unit 300 to which the fixing bolts 200 are fastened may have a circular shape to support the spring washer 201 and the flat washer 202. In addition, the hollow portion 301 may have a size greater than a size of the wheel 10 so that the first anti-vibration unit 300 passes the wheel 10 to be mounted on the plate 100.

Like the first embodiment, a first anti-vibration member 320 may be inserted into and seated on a first seating portion 311 formed in the periphery portion 302 of the first anti-vibration block 310. However, the first anti-vibration member 320 in contact with the plate 100 may have a size greater than or equal to a size of the plate 100.

Like the second embodiment of the first anti-vibration unit 300, since all of the fixing bolts 200 are fastened to one first anti-vibration unit 300 to be mounted in the plate 100, all of the fixing bolt 200 may be constrained to one first anti-vibration unit 300. That is, not only vibrations transmitted from the equipment 20 are blocked from being transmitted to the wheel 10 by the first anti-vibration unit 300 and the second anti-vibration unit 400, but also there is an effect in that vibrations generated by the fixing bolt 200 may also be blocked by constraining the fixing bolts 200 to each other, which fix the plate 100, using the first anti-vibration unit 300.

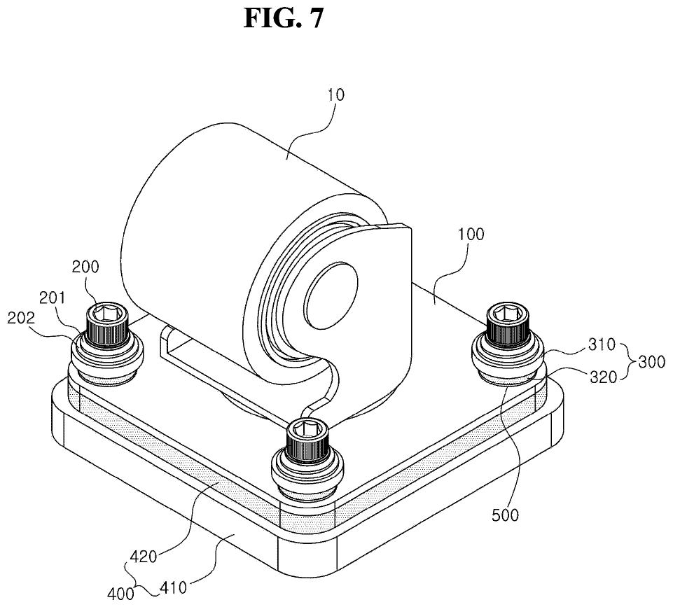

FIG. 7 is a perspective view illustrating a structure for preventing vibrations according to a third embodiment of the present inventive concept.

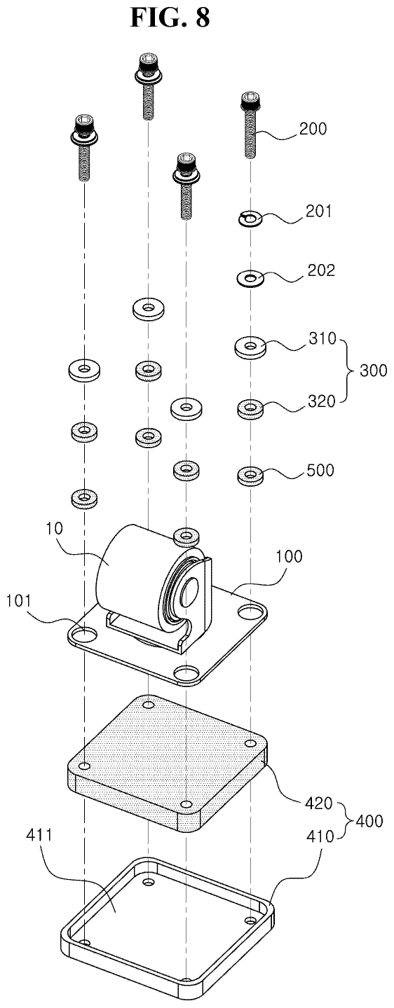

FIG. 8 is an exploded view illustrating the structure for preventing vibrations illustrated in FIG. 7.

Referring to FIGS. 7 and 8, in the structure for preventing vibrations according to the third embodiment of the present inventive concept, a fastening method of a plate 100 to which a wheel 10 is fixed, fixing bolts 200, first anti-vibration units 300, and a second anti-vibration unit 400 is the same as the fastening methods according to the first and second embodiments.

That is, the fixing bolt 200, to which a spring washer 201 and a flat washer 202 are coupled, is inserted into a fastening hole 101, in which a packing 500 is mounted, of the plate 100, using the first anti-vibration unit 300 and is mounted in a lower surface of an equipment 20 using the second anti-vibration unit 400.

However, the first anti-vibration unit 300 disposed between the fixing bolt 200 or the flat washer 202 and the plate 100 may have a circular or quadrangular shape.

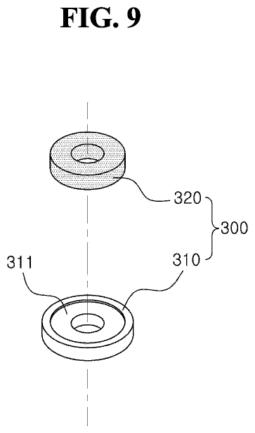

FIG. 9 is a view illustrating the first anti-vibration unit of the structure for preventing vibrations illustrated in FIG. 7.

Referring to FIGS. 7 to 9, the first anti-vibration unit 300 may include a first anti-vibration block 310 and a first anti-vibration member 320.

The first anti-vibration block 310 may have a size, which does not interfere with the wheel 10 when the first anti-vibration block 310 is mounted on the plate 100 using the fixing bolt 200, and may have a circular or quadrangular shape. As an example, when the first anti-vibration block 310 has the circular shape, since the size of the first anti-vibration block 310 may be increased while the first anti-vibration block 310 avoids interference with the wheel 10 disposed at a center of the plate 100 as much as possible, the first anti-vibration block 310 may have the circular shape rather than the quadrangular shape.

In addition, the other surface of the first anti-vibration block 310 may include a first seating portion 311 on which the first anti-vibration member 320 is seated. The first seating portion 311 may have the same shape as a shape of the first anti-vibration member 320 and the same size as a size of the first anti-vibration member 320 so that the first anti-vibration member 320 is fixedly inserted into the first seating portion 311. As an example, when a cross section of the first anti-vibration member 320 has a circular shape, the first seating portion 311 may have a circular shape having the same size as a size of one surface of the first anti-vibration member 320, and when the cross section of the first anti-vibration member 320 has a quadrangular shape, the first seating portion 311 may have a quadrangular shape having the same size as a size of one surface of the first anti-vibration member 320.

However, when the first anti-vibration member 320 is inserted into and seated on the first seating portion 311, the first anti-vibration member 320 may be disposed to protrude from the first anti-vibration block 310 in order to prevent the first anti-vibration block 310 formed of a metal material from being in contact with the plate 100.

The first anti-vibration member 320 may be disposed between the first anti-vibration block 310 and the plate 100. As an example, the first anti-vibration member 320 may be formed of an elastic rubber material to absorb vibrations, which are transmitted through the fixing bolt 200, of the equipment.

As described above, the first anti-vibration member 320 may be inserted into the first seating portion 311 of the first anti-vibration block 310 and fixedly compressed to the plate 100 by a pressing force of the first anti-vibration block 310 when the fixing bolt 200 is coupled thereto. That is, the first anti-vibration member 320 may block the fixing bolt 200 from being in direct contact with the plate 100. Accordingly, vibrations of the fixing bolt 200 may be blocked from being transmitted to the wheel 10 through the plate 100 by the first anti-vibration member 320. In addition, since the first anti-vibration unit 300 according to the third embodiment has the circular or quadrangular shape to be connected to the separate fixing bolts 200, there are advantages in that manufacturing is simple and manufacturing costs are reduced when compared to the first anti-vibration unit 300 according to each of the first and second embodiments.

The following Table 1 shows a result of measuring and comparing vibrations of equipment to which the structure for preventing vibrations of the present inventive concept is not applied and vibrations of equipment to which the structure for preventing vibrations is applied.

TABLE 1

| | Equipment to which structure for | Equipment to which structure for preventing | |
|---|---|---|---|
| | preventing vibrations is not applied | vibrations is applied | |
| Classification | Vibration Data (μm/s) | Vibration Data (μm/s) | Reduction Rate (%) |
| 1 | 320 | 96 | 70 |
| 2 | 320 | 95 | 70 |
| 3 | 321 | 96 | 70 |
| Average | 320 | 96 | 70 |

Referring to Table 1, in the case of the equipment to which the structure for preventing vibrations of the present inventive concept is not applied, when vibrations generated by the equipment are measured, a vibration of 320 μm/s is measured, however in the case of the equipment to which the structure for preventing vibrations of the present inventive concept is applied, a vibration of 96 μm/s is measured, and it may be seen that about 70% of the vibration is reduced when compared to the equipment to which the structure for preventing vibrations is not applied.

As described above, in the structure for preventing vibrations according to the present inventive concept, since the anti-vibration units 300 and 400 for blocking vibrations generated by the equipment 20 are mounted on the wheel 10 disposed on a lower end of the equipment 20, the vibrations generated by the equipment 20 may be blocked from being transmitted to a steel grating, which is the lower structure G, through the wheel 10, and since the anti-vibration units 300 and 400 are formed to surround the fixing bolt 200 for fixing the wheel 10 to the equipment 20, vibrations, which are transmitted through the fixing bolt 200, of the equipment 20 may be blocked. In addition, since the anti-vibration units 300 and 400 are mounted on the wheel 10 which is basically mounted on the equipment 20, there is no need to mount a separate structure for preventing vibrations on the lower end of the equipment 20, and thus an accident due to mounting or removal of the separate structure for preventing vibrations may be prevented.

According to the present inventive concept, since an anti-vibration unit for blocking vibrations generated by equipment is mounted on a wheel installed on a lower end of the equipment, the vibrations generated by the equipment can be prevented from being transmitted to a steel grating, which is a lower structure, through the wheel.

In addition, since the anti-vibration unit is formed to surround a fixing bolt for fixing the wheel to the equipment, the vibrations, which are transmitted through the fixing bolt, of the equipment can be blocked.

Furthermore, since the anti-vibration unit is mounted on the wheel basically installed on the equipment, there is no need to mount a separate structure for preventing vibrations on a lower end of the equipment, and thus an accident due to mounting or removal of the separate structure for preventing vibrations can be prevented.

Technical effects of the present inventive concept are not limited to the above-described effects, and other technical effects, which are not described above, will be clearly understood from the descriptions described above by those skilled in the art.

Meanwhile, the embodiments disclosed in this specification and drawings propose only examples to facilitate understanding and do not limit the range of the present inventive concept. It is clear to those skilled in the art that various modifications based on the technological scope of the invention may be made in addition to the embodiments disclosed herein.

What is claimed is:

1. A structure for preventing vibrations of equipment, the structure comprising:
a plate on which a wheel is mounted and which has fastening holes to be fixed to equipment;
a plurality of fixing bolts which are inserted into the fastening holes to fix the plate to the equipment;
a first anti-vibration unit disposed between a head portion of at least one of the plurality of fixing bolts and the plate; and
a second anti-vibration unit disposed between the plate and the equipment.

2. The structure of claim 1, wherein the first anti-vibration unit includes:
a first anti-vibration block which allows at least one of the plurality of fixing bolts to press the plate; and
a first anti-vibration member disposed between the first anti-vibration block and the plate.

3. The structure of claim 2, wherein the first anti-vibration block includes a first seating portion into which the first anti-vibration member is fixedly inserted.

4. The structure of claim 3, wherein the first anti-vibration member inserted into the first seating portion is disposed to protrude from the first anti-vibration block.

5. The structure of claim 1, wherein the first anti-vibration unit has a bar shape and
wherein each of a first end and a second end of the first anti-vibration unit is formed in a circular shape, the first end being opposite the second end.

6. The structure of claim 5, wherein at least one of the plurality of fixing bolts is mounted in each of a first end and a second end of the first anti-vibration unit, the first end being opposite the second end.

7. The structure of claim 1, wherein the first anti-vibration unit has a circular or quadrangular ring shape in which a hollow portion is formed in a central portion and all of the plurality of fixing bolts are fastened to a periphery portion.

8. The structure of claim 7, wherein the first anti-vibration unit has a size greater than or equal to a size of the plate.

9. The structure of claim 1, wherein the first anti-vibration unit has a circular shape.

10. The structure of claim 9, wherein the first anti-vibration unit is mounted on each of the fixing bolts fastened to the plate.

11. The structure of claim 1, wherein the second anti-vibration unit includes:
a second anti-vibration block in contact with the equipment; and
a second anti-vibration member disposed between the second anti-vibration block and the plate.

12. The structure of claim 11, wherein the second anti-vibration block includes a second seating portion into which the second anti-vibration member is fixedly inserted.

13. The structure of claim 12, wherein the second anti-vibration member inserted into the second seating portion is disposed to protrude from the second anti-vibration block.

14. The structure of claim 11, wherein the second anti-vibration member has an area greater than or equal to an area of the plate.

15. The structure of claim 1, further comprising a packing disposed in the fastening holes of the plate.
